(19) United States
(12) Patent Application Publication
(10) Pub. No.: US 2008/0295298 A1
(43) Pub. Date: Dec. 4, 2008

(54) MAGNETIC DEVICE AND METHOD

(76) Inventor: John S. Shepard, Fort Collins, CO (US)

Correspondence Address: ANCEL W. LEWIS, JR., 425 WEST MULBERRY, SUITE 101, FORT COLLINS, CO, 80521, US

(21) Appl. No.: 11/755,133

(22) Filed: May 30, 2007

(51) Int. Cl. A44B 21/00; A45C 13/10; B42D 9/00; G09F 7/04

(52) U.S. Cl. 24/303; 116/237; 29/428; 40/1.5

(57) ABSTRACT

A magnetic device used as a bookmark and a nametag. The device includes a strip of sheet material including first, second, third and fourth panels folded along first, second and third fold lines. First and second magnets, preferably of the rare earth type, are secured between selected folded panels forming clamping jaws that fasten the device to a page in a book or to clothing. Selected printed indicia information on the panels may display advertising, business card information, use instructions, and appointments so the device may serve as both a bookmark and a nametag.

### TECHNICAL FIELD

This invention relates to devices that are suitable for being firmly releasably fastened to a support member and may function to serve as a bookmark or a nametag.

### BACKGROUND ART

There is a need for a device that can be firmly fastened to and readily released from a support member and be reused many times. Some attempts have been made to provide magnetic bookmarks using sheets of magnetic material. The drawback of sheets of magnetic material for this purpose is they are heavy and thick. Thickness is not desirable between thin pages of a book and heaviness causes the page to bend down. Also these magnets are not as strong as the rare earth magnets of the present invention. There is no known magnetic device that can be effectively used as both a bookmark and nametag that can convey a variety of types of information including business card indicia, advertising indicia, instruction indicia and appointment indicia.

### SUMMARY OF THE INVENTION

A magnet device and method of making includes a strip of sheet material having first, second, third and fourth panels connected at folds. When folded along the folds and provided with two magnets secured between selected of the panels the device is firmly releasably fasten to a page in a book to serve as a bookmark or to clothing to serve as a nametag. Each panel may have selected printed information including business card indicia, instruction indicia, advertising indicia, and appointment indicia. The printed information is on only one face of the strip of sheet material to minimize printing costs.

### DETAILED DESCRIPTION OF THE DRAWINGS

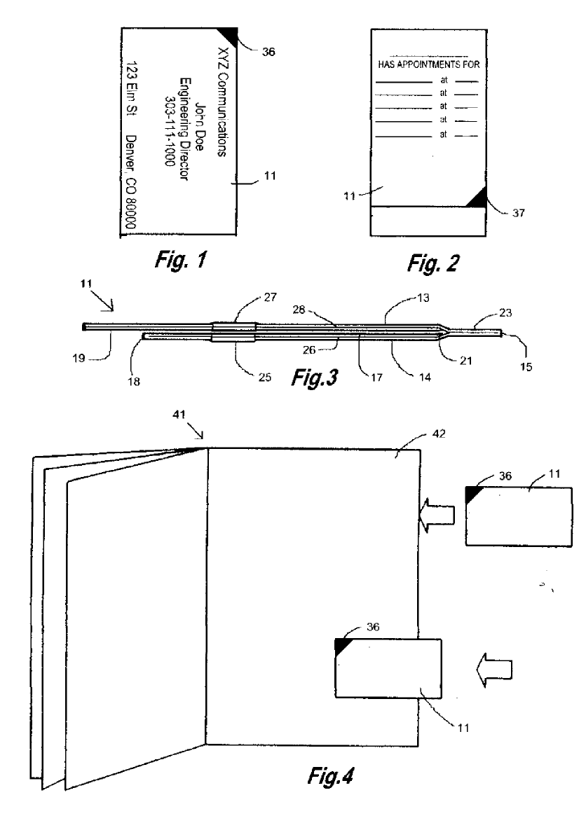

FIG. 1 is a front view of a magnetic device embodying features of the present invention.

FIG. 2 is a rear view of the device shown in FIG. 1.

FIG. 3 is a side view of the device shown in FIGS. 1 and 2 drawn to a larger scale.

FIG. 4 is a front view showing the device of FIGS. 1-3 in removed and attached positions as the device is used as a bookmark.

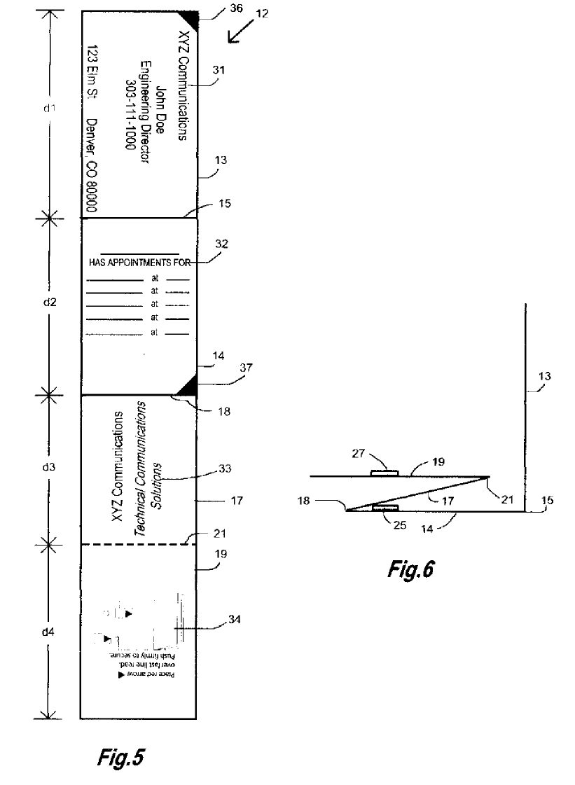

FIG. 5 is a front view of a flat strip of material prior to being folded and the magnets attached showing the panel faces having different indicia.

FIG. 6 is a side view showing the strip of material with the panels of FIG. 5 partially folded for explaining the method of making the device.

The magnetic device 111 shown in FIGS. 1-6 is particularly suitable for use as a bookmark comprises a one piece strip of material 12 preferably lightweight paper such as that used for business cards. The strip of material 12 includes a first panel 13 and a second panel 14 connected to the first panel at a first fold 15. The strip of material 12 further includes a third panel 17 connected to the second panel at a second fold 18 and a fourth panel 19 connected to the third panel at a third fold 21. The first and second folds 15 and 18 may be a crease or a score. The third fold 21 preferably is perforated as indicated by dashed lines so the panels connected at the third fold will flatten one against the other so the device will have more contact and friction between opposed surfaces forming the gripping jaws thus holding better without slipping.

The third panel 17 is folded back on the second panel 14 leaving a space between the first fold 15 and the third fold 21 with an end portion of the first and second panels for forming a tab 23 between folds 15 and 21. The fourth panel 19 is folded back on the third panel 17. The tab 23 projects or protrudes beyond the outer edge of the page to which the device 11 is attached for gripping by the user to slide the device 11 on the page.

A first magnet 25 is disposed between the second and third panels 14 and 17 in close proximity to second fold 18. Panels 14 and 17 are held or secured together by suitable means. Preferably, first adhesive layer 26 is provided between second panel 14 and third panel 17 to hold these panels together and secure the first magnet 25 in place. A second magnet 27 is disposed between the fourth and first panels 19 and 13 opposite magnet 25. Panels 19 and 13 are held or secured together by suitable means. Preferably, a second adhesive layer 28 is provided between fourth panel 19 and first panel 13 to hold these panels together and secure second magnet 27 in place. The magnets preferably are rare earth magnets trapped between two sheets of paper. This type of magnet has advantages over sheets of magnetic material including being lighter and being able to provide more holding power and have greater ease of assembly. In use third and fourth panels 17 and 19 form clamping jaws that come together to grip a support member to releasably fasten the panels to a support member such as a page in a book as described hereafter.

The panels have selected printed information on an outer face. In the embodiment shown the first panel 21 has business card indicia 31, the second panel 14 has appointment indicia 32, the third panel 17 has advertising indicia 33. The fourth panel 19 has bookmark instructions use indicia 34.

A first marker 36 in the form of an arrow printed at a corner on the first panel allows the reader to mark the written line where the user left off reading. A second marker 37 in the form of an arrow at the corner of the fourth panel allows the reader to mark the written line where the user left off reading when the device 11 is turned over.

Referring now to FIG. 4 there is shown a book 41 having a plurality of pages 42. In use the arrow 36 is placed over the last line read. The device 11 inwardly is presented along the line until the third fold 21 bears against the edge of the page. The attracting magnets 25 and 27 hold the device in place and it can be moved by sliding the device to a desired location on the page with the final position having the third fold 21 bearing against the edge of the page.

The method of making the above described magnetic device 11 is described with reference to FIGS. 5 and 6. The one piece strip of material 12 begins in a flat condition having dimensions of a selected length and width. The printing of selected information herein referred to as “indicia” on the panels is accomplished prior to folding. The strip of material 12 includes the first panel 13 having a length dimension d1, second panel 14 having a length dimension d2, third panel 17 having a length dimension d3 and a fourth panel 19 having a length dimension d4. The panels 13, 14, 17 and 18 are connected at first, second, third folds 15, 18 and 21, respectively, as above described.

The first magnet 25 is placed on the second panel 14 adjacent and in close proximity to the second fold 18. The adhesive 26 is placed on the second panel on the sides and at the end and around the first magnet 25. The third panel 17 is folded back on the second panel 14. The third panel 17 is pressed against the adhesive 26 to secure the second panel to the third panel and secure the first magnet in place. The second magnet 27 is placed on the fourth panel 19 with the second magnet moving directly opposite the first magnet due to magnetic attraction. This also establishes the correct polarity for the magnets to cause attraction when brought together. An adhesive 28 is placed on the fourth panel 19 along the sides and end and around the second magnet 27. The first panel is folded against the fourth panel and the adhesive to secure the first and fourth panels 17 and 19 together and secure the second magnet 27 in place.

By way of illustration and not limitation the dimensions for the above described strip 12 are:

Width=2 inches

d1=3½ inches

d2=3 inches

d3=2½ inches

d4=3 inches

The above described device 11 may also be used as a nametag. In this case the device is fastened to a portion of clothing such as to a collar or and to an edge portion of a shirt where the shirt buttons. The business card indicia displays the name of the wearer.

Although the present invention has been described with a certain degree of particularity, it is understood that the present disclosure has been made by way of example and that changes in details of structure may be made without departing from the spirit thereof.

What is claimed is:

1. A magnetic device for releasably fastening to a support member comprising:
a strip of sheet material including:
a first panel and a second panel connected to said first panel at a first fold,
a third panel connected to said second panel at a second fold,
a fourth panel connect to said third panel at a third fold,
said third panel being folded back on said second panel leaving a space between said first fold and said third fold to form a tab between said first fold and said third fold,
said fourth panel being folded back on said third panel,
a first magnet held between said second and third panels
a second magnet held between said fourth and first panels,
said third and fourth panels forming clasping jaws that come together to grip a support member to releasably fasten said panels to said support member and
whereby when said magnets come together said strip is releasably fastened to said support member and when said magnets are separated said strip is released from said support member.

2. The magnetic device as set forth in claim 1 wherein said support member is a page in a book.

3. The magnetic device as set forth in claim 1 wherein said support member is clothing worn by a user.

4. The magnetic device as set forth in claim 1 wherein said first and second magnets are rare earth magnets.

5. The magnetic device as set forth in claim 1 wherein said strip of sheet material is paper.

6. The magnetic device as set forth in claim 1 wherein said strip has a first marker on one of said panels that allows a reader to mark the written line on a page where the reader left off reading.

7. The magnetic device as set forth in claim 1 wherein said strip has a second marker on a face of another of said panels that allows the reader to mark the written line on a page where the reader left off when the device is inverted.

8. The magnetic device as set forth in claim 1 wherein said strip has printed information on one face only to minimize printing costs.

9. The device as set forth in claim 1 wherein one of said folds is perforated to provide more contact and friction between said jaws.

10. A magnetic device for releasably fastening to a support member comprising:
an elongated one piece strip of sheet material including:
a first panel and a second panel connected to said first panel at a first fold,
a third panel connected to said second panel at a second fold, a fourth panel connect to said third panel at a third fold
said third panel being folded back on said second panel leaving a space between said first fold and said third fold to form a tab between said first fold and said third fold that protrudes beyond an outer edge of said support member,
said fourth panel being folded back on said third panel,
a first magnet between said second and third panels,
a second magnet between said fourth and first panels,
a first adhesive layer holding said second and third panels together and said first magnet in place,
a second adhesive layer holding said fourth and first panels together and said second magnet in place,
said third and fourth panels embracing a support member to releasably fasten said strip to said support member and
said third fold engaging an edge of said support member to limit how far said third and fourth panels extend inwardly of said edge
whereby when said magnets come together said strip is releasably fastened to said support member and when said magnets are separated said strip is released from said support member.

11. The magnetic device as set forth in claim 10 wherein said first panel has business card indicia.

12. The magnetic device as set forth in claim 10 wherein said second panel has bookmark use instruction indicia.

13. The magnetic device as set forth in claim 10 wherein said third panel has appointment indicia.

14. The magnetic devise as set forth in claim 10 wherein said fourth panel has advertising indicia.

15. A method of making a magnetic device for releasably fastening to a support member comprising the steps of:
providing a strip of material including a first panel and a second panel connected to said first panel at a first fold line, a third panel connected to said second panel at a second fold and a fourth panel connected to said third panel at a third fold,
placing a first magnet on said second panel in close proximity to said second fold,
folding said third panel back on said second panel at said second fold, said third panel being secured to said second panel to secure said first magnet in place,
placing a second magnet on said fourth panel with said second magnet moving opposite said first magnet due to magnetic attraction to provide the correct polarity for said magnets to cause attraction between said magnets,
folding said first panel against said fourth panel and securing said first and fourth panels together and secure said second magnet in place,
whereby when said magnets come together said strip is releasably fastened to a support member and when said magnets are separated said strip is released from said support member.

16. A method of making a magnetic device for releasably fastening to a support member comprising the steps of:
providing a strip of material including a first panel and a second panel connect to said first panel at a first fold line, a third panel connected to said second panel at a second fold and a fourth panel connected to said third panel at a third fold,
printing selected indicia on selected of said panels,
placing a first magnet on said second panel adjacent said second fold,
placing an adhesive on said second panel,
folding said third panel back on said second panel at said second fold, said third panel being pressed against said adhesive to secure said second panel to said third panel and secure said first magnet in place,
placing a second magnet on said fourth panel with said second magnet moving opposite said first magnet due to magnetic attraction to provide the correct polarity for said magnets to cause attraction between said magnets,
placing a second layer of adhesive on said fourth panel,
folding said first panel against said fourth panel and against said second layer of adhesive to secure said first and fourth panels together and secure said second magnet in place,
whereby when said magnets come together said strip is releasably fastened to a support member and when said magnets are separated said strip is released from said support member.
